(19) United States
(12) Patent Application Publication
(10) Pub. No.: US 2022/0000699 A1
(43) Pub. Date: Jan. 6, 2022

(54) LOAD REDUCTION ASSISTANCE DEVICE, LOAD REDUCTION ASSISTANCE SYSTEM, LOAD REDUCTION ASSISTANCE METHOD, PROGRAM, AND STORAGE MEDIUM FOR STORING PROGRAM

(71) Applicant: NEC Corporation, Minato-ku, Tokyo (JP)

(72) Inventor: Tadashi OOKOBA, Tokyo (JP)

(73) Assignee: NEC Corporation, Minato-ku, Tokyo (JP)

(21) Appl. No.: 17/292,925

(22) PCT Filed: Nov. 8, 2019
(86) PCT No.: PCT/JP2019/043858

§ 371 Date: May 11, 2021

(30) Foreign Application Priority Data
Nov. 13, 2018 (JP) 2018-212804

(51) Int. Cl. A61H 3/00; G05B 19/4155

(52) U.S. Cl. CPC A61H 3/00; G06F 3/011; G05B 19/4155

(57) ABSTRACT

A load reduction assistance device is provided with an acquisition unit configured to acquire position information of a user wearing a load reduction device that reduces a load on the user; a status detection unit configured to extract an operation mode of the load reduction device corresponding to a surrounding environment state based on the position information of the user; and an operation control unit configured to cause the load reduction device to operate in the extracted operation mode.

### TECHNICAL FIELD

The present invention relates to a load reduction assistance device, a load reduction assistance system, a load reduction assistance method, a program, and a storage medium for storing the program.

### BACKGROUND ART

There is known a load reduction device that performs assistance of a load such as a walking motion of a user when worn by the user and mitigates the load of luggage carried by the user. When wearable by a person, the load reduction device is sometimes called a powered suit.

Some powered suits assist walking movement by driving a link mechanism provided on the user's legs by outputting torque from actuators to assist muscle strength. Patent Document 1 discloses a wearable action supporting apparatus that, on the basis of a myoelectric potential (biometric signal) by a wearer, alters torque generated on an actuator to control the assisting force to reflect an intention of the wearer.

### CITATION LIST

### Patent Literature

[Patent Document 1] Japanese Unexamined Patent Application Publication No. 2005-230099

### SUMMARY OF THE INVENTION

### Problems to be Solved by the Invention

However, depending on the state of the passage where the user is walking and the surrounding environment such as the weather, there is a possibility that it is not possible to provide appropriate load reduction control according to the assumed operation of the user.

Therefore, an example object of the present invention is to provide a load reduction assistance device, a load reduction assistance system, a load reduction assistance method, a program, and a storage medium for storing the program therein that can solve the above-mentioned problems.

### Means for Solving the Problems

According to a first aspect of the present invention, a load reduction assistance device is provided with: an acquisition unit configured to acquire position information of a user wearing a load reduction device that reduces a load on the user; a status detection unit configured to extract an operation mode of the load reduction device corresponding to a surrounding environment state based on the position information of the user; and an operation control unit configured to cause the load reduction device to operate in the extracted operation mode.

According to a second aspect of the present invention, a load reduction assistance system includes a load reduction assistance device and a load reduction device that reduces a load on a user. The load reduction assistance device is provided with an acquisition unit configured to acquire position information of the user; a status detection unit configured to extract an operation mode of the load reduction device corresponding to a surrounding environment state based on the position information of the user; and an operation control unit configured to cause the load reduction device to operate in the extracted operation mode.

According to a third aspect of the present invention, a load reduction assistance method include acquiring position information of a user wearing a load reduction device that reduces a load on the user; extracting an operation mode of the load reduction device corresponding to a surrounding environment state based on the position information of the user; and causing the load reduction device to operate in the extracted operation mode.

According to a fourth aspect of the present invention, a program stored in a storage medium causes a computer of a load reduction assistance device to execute processes. The processes includes acquiring position information of a user wearing a load reduction device that reduces a load on the user; extracting an operation mode of the load reduction device corresponding to a surrounding environment state based on the position information of the user; and causing the load reduction device to operate in the extracted operation mode.

According to a fifth aspect of the present invention, a program causes a computer of a load reduction assistance device to perform processes. The processes includes acquiring position information of a user wearing a load reduction device that reduces a load on the user; extracting an operation mode of the load reduction device corresponding to a surrounding environment state based on the position information of the user; and causing the load reduction device to operate in the extracted operation mode.

### Advantageous Effects of Invention

According to the present invention, it is possible to provide more suitable load reduction control according to the user's situation.

### BRIEF DESCRIPTION OF THE DRAWINGS

FIG. 1 is a diagram showing a configuration of a load reduction assistance system according to the first embodiment of the present invention.

FIG. 2 is a diagram showing a configuration of a powered suit according to the first embodiment of the present invention.

FIG. 3 is a diagram showing a hardware configuration of a control device according to the first embodiment of the present invention.

FIG. 4 is a function block diagram of the control device according to the first embodiment of the present invention.

FIG. 5 is a diagram showing a hardware configuration of the load reduction assistance device according to the first embodiment of the present invention.

FIG. 6 is a function block diagram of the load reduction assistance device according to the first embodiment of the present invention.

FIG. 7 is a diagram showing a processing flow of a load reduction assistance system according to the first embodiment of the present invention.

FIG. 8 is a diagram showing a processing flow of a load reduction assistance system according to a second embodiment of the present invention.

FIG. 9 is an image diagram showing an example of an operation mode selection screen according to the second embodiment of the present invention.

FIG. 10 is a diagram showing another example of the control device of the present invention.

FIG. 11 is a diagram showing a minimum configuration of the load reduction assistance device of the present invention.

FIG. 12 is a diagram showing a configuration of a load reduction assistance system having a plurality of user situation acquisition sensors and a powered suit.

### EXAMPLE EMBODIMENT

Hereinbelow, a load reduction assistance device, a load reduction assistance system, a load reduction assistance method, a program, and a storage medium for storing the program according to an embodiment of the present invention will be described with reference to the drawings.

### First Embodiment

First, the first embodiment will be described.

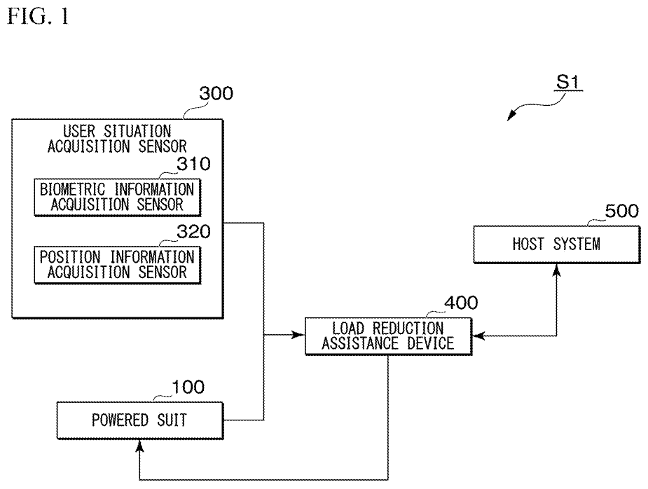

FIG. 1 is a diagram showing a configuration of a load reduction assistance system according to the first embodiment of the present invention.

As shown in this diagram, a load reduction assistance system S1 in the present embodiment is provided with, for example, a powered suit 100, a user situation acquisition sensor 300, a load reduction assistance device 400, and a host system 500.

The powered suit 100 is an aspect of a load reduction device that reduces the load on the user.

The user situation acquisition sensor 300 is provided with a biometric information acquisition sensor 310 and a position information acquisition sensor 320 as an example, and acquires user situation information indicating the situation of the user. The biometric information acquisition sensor 310 is, for example, a thermometer or a heart rate monitor, and acquires biometric information such as a user's body temperature and heart rate. The position information acquisition sensor 320 is, for example, a GPS (Global Positioning System), and acquires the user's position information. The user situation acquisition sensor 300 is pre-attached to, for example, clothing of the user. Thereby, since the user can wear the user situation acquisition sensor 300 simply by putting on clothes, handling is extremely easy.

The load reduction assistance device 400 is a computer that assists the operation of the powered suit 100.

The host system 500 is a server device such as a command system that controls the load reduction assistance system S1 in a centralized manner. The host system 500 is composed of one or a plurality of computers.

The load reduction assistance device 400, and the user situation acquisition sensor 300 and the powered suit 100 communicate wirelessly. The load reduction assistance device 400 and the host system 500 communicate with each other by wire or wirelessly via a wide area communication network such as the Internet.

In the example of FIG. 1, the load reduction assistance system illustrates one combination of the user situation acquisition sensor 300 and the powered suit 100. However, the present invention is not limited to this example. The load reduction assistance system may have a plurality of combinations of the user situation acquisition sensor 300 and the powered suit 100. In this case, the load reduction assistance device 400 communicates with each of the plurality of combinations.

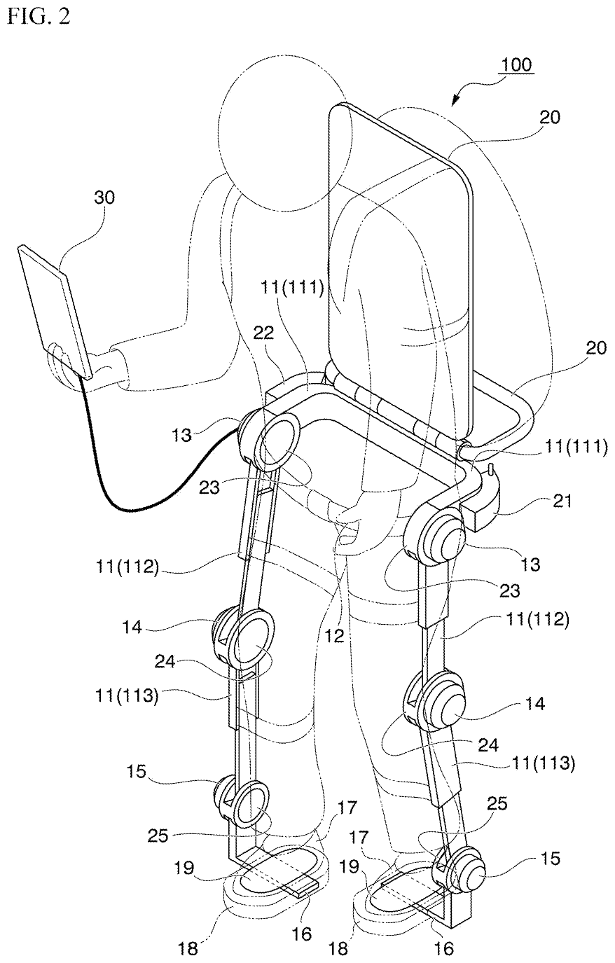

FIG. 2 is a diagram showing a configuration of the powered suit according to the present embodiment.

The powered suit 100 is one aspect of a load reduction device. The powered suit 100 is constituted by a skeleton portion 11, a belt 12, a hip actuator 13, a knee actuator 14, an ankle actuator 15, a shoe sole plate 16, a foot harness 17, a shoe sole load sensor 18, a foot sole load sensor 19, a loading platform 20, a control device 21, a battery 22, a hip joint sensor 23, a knee joint sensor 24, an ankle joint sensor 25, a display unit 30, and the like. As an example, the skeleton portion 11 is roughly classified into a first skeleton portion 111, a second skeleton portion 112, and a third skeleton portion 113.

As illustrated, the powered suit 100 is constituted as follows so as to support the loading platform 20, which is one aspect of the mechanism for holding luggage as an example. That is, the powered suit 100 is provided with the first skeleton portion 111, and the left and right hip actuators 13 are coupled rotatable to the first skeleton portion 111 and the second skeleton portion 112, which corresponds to the left or right thigh portion of the user wearing the powered suit 100, respectively. The left and right knee actuators 14 couple rotatable the corresponding second skeleton portion 112 on the left or right side and the corresponding third skeleton portion 113 along the left or right lower leg portion of the user wearing the powered suit 100. The ankle actuators 15 couple rotatable to the corresponding third skeleton portion 113 on the left or right side, and a corresponding shoe sole plate 16 provided on the back of the foot harness 17 on the left or right side of the user wearing the powered suit 100.

The hip actuator 13, the knee actuator 14, and the ankle actuator 15 are drive mechanisms that output torque for rotationally driving a link (frame) connected at each joint of each leg of the user to reduce the load on the user. The first skeleton portion 111 and the second skeleton portion 112 are links to which the hip actuator 13 is connected. The second skeleton portion 112 and the third skeleton portion 113 are links to which the knee actuator 14 is connected. The third skeleton portion 113 and the shoe sole plate 16 are links to which the ankle actuator 15 is connected. Each link and drive mechanism constitute a link mechanism.

The hip joint sensor 23 is installed in the hip actuator 13, and detects the hip joint angle, that is, the angle formed between the first skeleton portion 111 and the second skeleton portion 112, by an encoder. The knee joint sensor 24 is installed in the knee actuator 14, and detects the knee joint angle, that is, the angle between the second skeleton portion 112 and the third skeleton portion 113, by the encoder. The ankle joint sensor 25 is installed in the ankle actuator 15, and detects the ankle joint angle, that is, the angle between the third skeleton portion 113 and the shoe sole plate 16, by the encoder. The hip joint sensor 23, the knee joint sensor 24, and the ankle joint sensor 25 detect the angle of each joint of each leg of the user (hereinafter referred to as the “joint angle”).

The shoe sole load sensor 18 is provided on the bottom of the foot harness 17 corresponding to the shoe worn by the user. The shoe sole load sensor 18 is provided on the ground contact surface side of the shoe sole plate 16 that transmits the weight of the powered suit 100 and luggage to the ground contact surface, and the foot harness 17 that transmits the user's weight to the ground contact surface so as to cover the entire back surface of the shoe sole plate 16 and the foot harness 17. The foot sole load sensor 19 is provided in the foot harness 17 so as to cover the entire underside of the foot so as to be able to measure the weight applied from the sole of the user.

As an example, electrodes are arranged in a matrix on the front and back of a thin sheet-like insulator in the shoe sole load sensor 18 and the foot sole load sensor 19. The shoe sole load sensor 18 and the foot sole load sensor 19 measure the electrical resistance of the lattice points of the electrodes, and output the measured values to the control device 21. The control device 21 calculates the pressure applied to each lattice point and the load on the entire surface of the sensor sheet on the basis of the electrical resistance value of each lattice point.

The display unit 30 is a display device such as an organic EL (Electro-Luminescence) display or a liquid crystal display. The display unit 30 is connected to the control device 21. A touch panel is arranged on the display surface of the display unit 30, and the display unit 30 receives inputs from the user.

The user who wears the powered suit 100 inserts his/her left and right feet into the corresponding foot harnesses 17, and fixes the first skeleton portion 111 to the waist with the belt 12 so that the first skeleton portion 111 is closely attached to the waist. The powered suit 100 has a structure in which most of the load of the luggage and the load of the powered suit 100 is released to the ground surface in contact with the soles of the feet via the skeleton portion 11 and the hip actuator 13, the knee actuator 14, and the ankle actuator 15. The user turns on the control device 21 of the powered suit 100. The control device 21 controls the hip actuator 13, the knee actuator 14, and the ankle actuator 15 so as to transmit as much of the device weight as possible, which is the sum of the load of the luggage loaded on the loading platform 20 and the weight of the powered suit 100, to the walking surface via the skeleton portion 11 and the hip actuator 13, the knee actuator 14, and the ankle actuator 15. Thereby, the powered suit 100 mitigates the burden such as the load of the luggage on the user who wears the powered suit 100 and performs various motions.

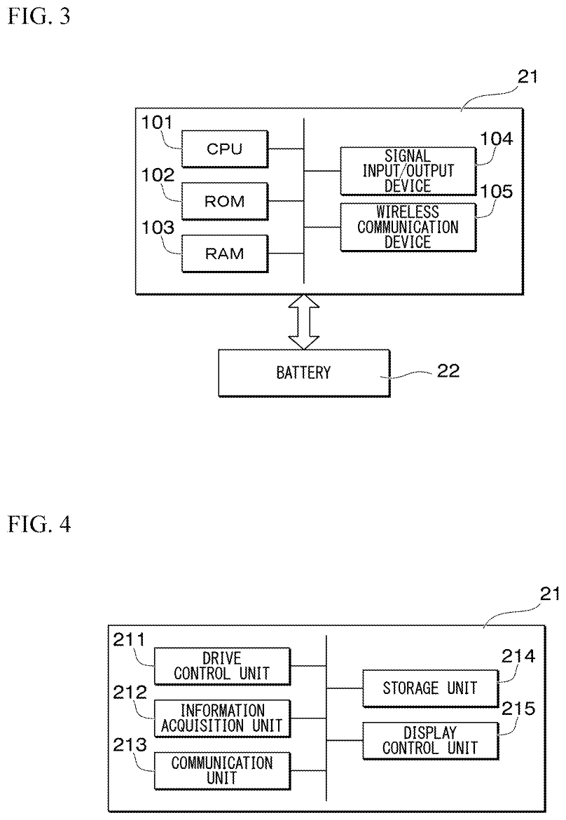

FIG. 3 is a diagram showing the hardware configuration of the control device according to the present embodiment.

As shown in this figure, the control device 21 is a computer provided with hardware such as a CPU (Central Processing Unit) 101, a ROM (Read Only Memory) 102, a RAM (Random Access Memory) 103, a signal input/output device 104, and a wireless communication device 105.

The signal input/output device 104 inputs signals output from the shoe sole load sensor 18, the foot sole load sensor 19, the hip joint sensor 23, the knee joint sensor 24, and the ankle joint sensor 25. The signal input/output device 104 outputs control signals for controlling the hip actuator 13, the knee actuator 14, and the ankle actuator 15. The control device 21 operates by power supplied from the battery 22.

The wireless communication device 105 is communicatively connected with the load reduction assistance device 400.

FIG. 4 is a function block diagram of the control device.

The control device 21 is activated based on the power supplied from the battery 22 when the power button is turned on. The control device 21 executes the control program after startup. As a result, the control device 21 is provided with at least the function configuration of a drive control unit 211, an information acquisition unit 212, a communication unit 213, a storage unit 214 and a display control unit 215.

The drive control unit 211 controls the hip actuator 13, the knee actuator 14, and the ankle actuator 15. The drive control unit 211 drives the hip actuator 13, the knee actuator 14, and the ankle actuator 15 in a user-suited operation mode notified from the load reduction assistance device 400, to reduce the load applied to the user. The operation modes include “running”, “walking”, “stopping”, and the like according to the type of action of the user. The control model corresponding to each operation mode is set in the control device 21 in advance. The drive control unit 211 calculates the torque output by the hip actuator 13, the knee actuator 14, and the ankle actuator 15 using the control model corresponding to each operation mode. Then, the drive control unit 211 outputs the calculated torque to the hip actuator 13, the knee actuator 14, and the ankle actuator 15.

The information acquisition unit 212 acquires sensing information from the shoe sole load sensor 18, the foot sole load sensor 19, the hip joint sensor 23, the knee joint sensor 24, and the ankle joint sensor 25. The sensing information of the shoe sole load sensor 18 and the foot sole load sensor 19 is load information indicating an electrical resistance value corresponding to the pressure (load) of the lattice points of each sensor. The sensing information of the hip joint sensor 23, the knee joint sensor 24, and the ankle joint sensor 25 is joint angle information indicating the detected joint angle.

The communication unit 213 wirelessly communicates with the load reduction assistance device 400.

The storage unit 214 stores various pieces of information such as an angle reference at each joint of the leg.

The display control unit 215 controls the display of the display unit 30. For example, the display control unit 215 displays on the display unit 30 reference information notified from the load reduction assistance device 400 together with the operation mode.

FIG. 5 is a diagram showing the hardware configuration of the load reduction assistance device according to the present embodiment.

As shown in this figure, the load reduction assistance device 400 is a computer equipped with hardware such as a CPU 401, a ROM 402, a RAM 403, a large-capacity storage device 404, and a communication module 405.

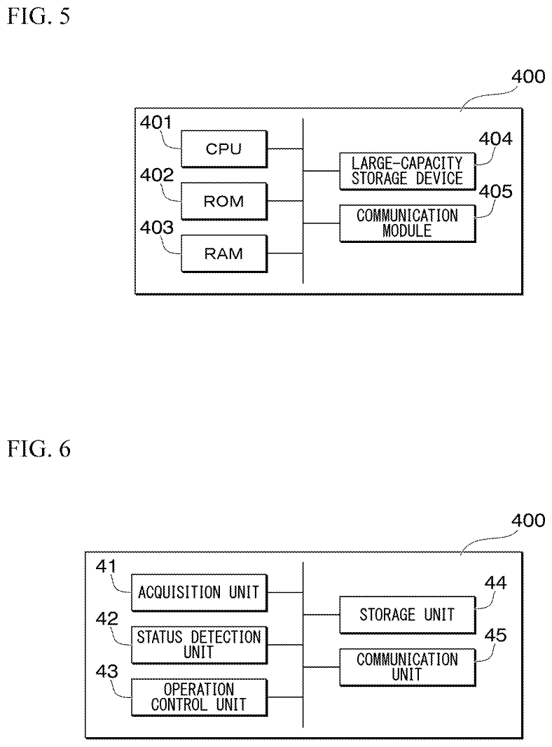

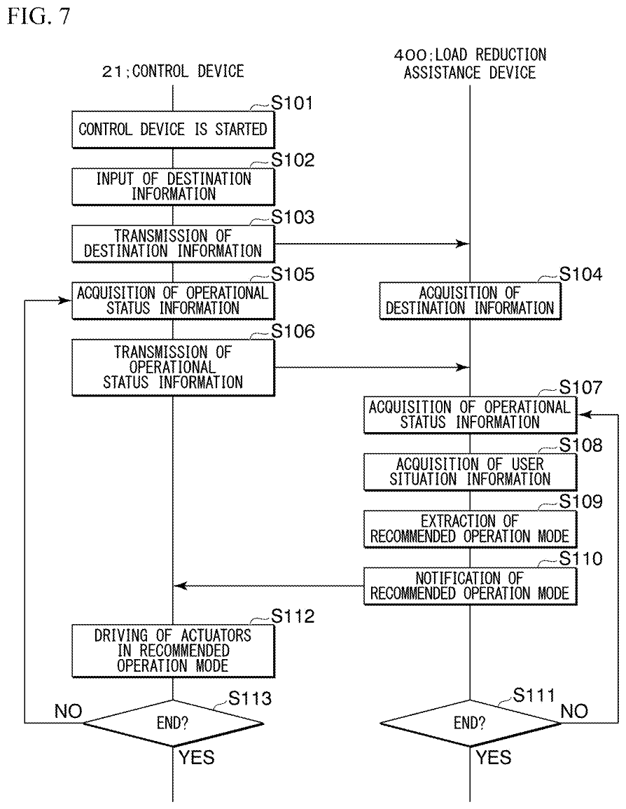

FIG. 6 is a functional block diagram of the load reduction assistance device according to the present embodiment.

The load reduction assistance device 400 starts when the power is turned on, and executes an operation program stored in advance. Thereby, the load reduction assistance device 400 is provided with at least the function configuration of the acquisition unit 41, the status detection unit 42, the operation control unit 43, the storage unit 44, and the communication unit 45.

The acquisition unit 41 acquires user situation information of the user wearing the powered suit 100 from the user situation acquisition sensor 300 (FIG. 1). The user situation information includes location information of the user and biometric information of the user. The acquisition unit 41 further acquires the operational status of the powered suit 100. The operational status includes the sensing information detected by the shoe sole load sensor 18, the foot sole load sensor 19, the hip joint sensor 23, the knee joint sensor 24, and the ankle joint sensor 25, and the current operation mode.

The status detection unit 42 extracts the operation mode of the powered suit 100 in accordance with the operational status of the powered suit 100, the surrounding environment state based on the user's position information, and the physical fatigue state based on the user's biometric information. The surrounding environment state includes any of the weather, state of a passage, conditions about a destination, companions, or other user situations.

The operation control unit 43 notifies the control device 21 of the powered suit 100 of the extracted operation mode to operate the powered suit 100 in the operation mode. The operation control unit 43 notifies the control device 21 of reference information based on the surrounding environment state and the fatigue state together with the extracted operation mode.

The storage unit 44 stores various pieces of information. For example, the storage unit 44 stores biometric information such as the user's normal body temperature and heartbeat. In addition, the storage unit 44 stores information indicating familiarity with other users, information indicating the height of cooperation, and the like.

The communication unit 45 is communicatively connected with the powered suit 100, the user situation acquisition sensor 300, or the host system 500.

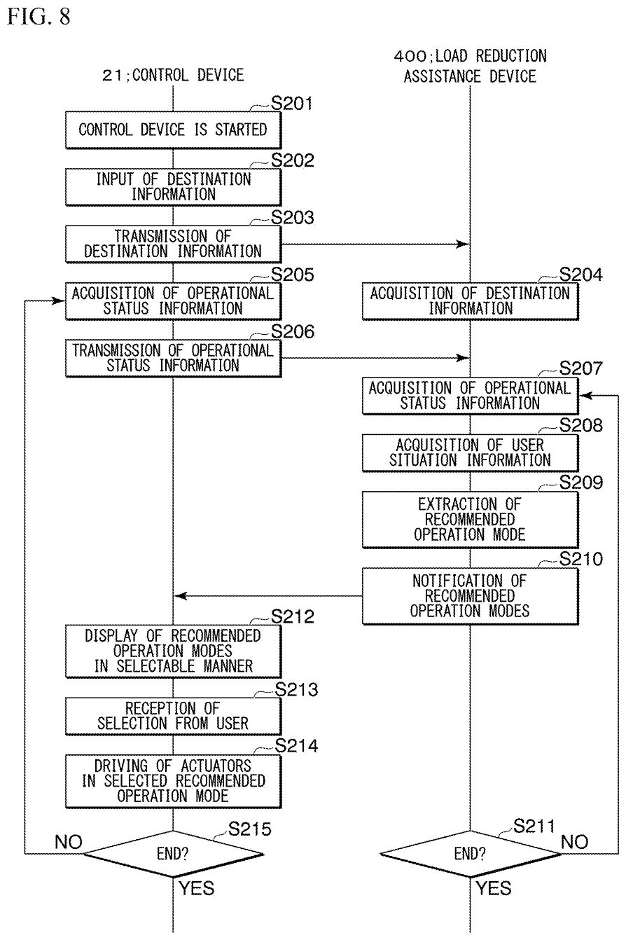

FIG. 7 is a diagram showing the processing flow of the load reduction assistance system according to the present embodiment. In the example of FIG. 7, the case where the load reduction assistance device 400 communicates with one control device 21 is illustrated, but the same applies to the case where the load reduction assistance device 400 communicates with a plurality of control devices 21.

First, the user puts on the powered suit 100. At this time, the user inserts the foot sole load sensor 19 inside the foot harness 17. As the area of the foot sole load sensor 19, a size suitable for the size of the user's foot may be used. The user attaches the shoe sole load sensor 18 to the ground contact surface side of the foot harness 17 or the shoe sole plate 16 of the powered suit 100. As the area of the shoe sole load sensor 18, a size suitable for the foot harness 17 corresponding to the size of the user's foot may be used.

The user operates the power button of the control device 21 provided in the powered suit 100 to turn on the power. Thereby, the control device 21 is started (Step S101).

The display control unit 215 of the control device 21 displays a destination input screen on the display unit 30 and accepts the input of the destination information (Step S102). On the destination input screen, the destination and the target arrival time can be input as the destination information. The target arrival time is the target time to arrive at the destination. The user inputs the destination information in the destination input screen. The display unit 30 outputs the input destination information to the control device 21.

The communication unit 213 of the control device 21 transmits the destination information to the load reduction assistance device 400 (Step S103). The acquisition unit 41 of the load reduction assistance device 400 receives and acquires the destination information transmitted from the control device 21 (Step S104). The acquisition unit 41 writes the received destination information to the storage unit 44.

The user walks while wearing the powered suit 100. The user may load luggage on the loading platform 20 of the powered suit 100 and walk. The drive control unit 211 of the control device 21 controls the hip actuator 13, the knee actuator 14, and the ankle actuator 15 so as to reduce the load on the user due to the weight of the luggage and the powered suit 100. Thereby, the powered suit 100 tracks various motions of the user.

While the control device 21 is being driven, the information acquisition unit 212 acquires the sensing information from the shoe sole load sensor 18, the foot sole load sensor 19, the hip joint sensor 23, the knee joint sensor 24, and the ankle joint sensor 25 at predetermined intervals as operational status information (Step S105). The predetermined interval is, for example, every short time such as every 10 milliseconds. The information acquisition unit 212 records the operational status information acquired at predetermined intervals in the storage unit 214 in an associated manner. The communication unit 213 adds the current operation mode to the operational status information recorded in the storage unit 214 via the wireless communication device 105, and transmits the information to the load reduction assistance device 400 (Step S106).

The acquisition unit 41 of the load reduction assistance device 400 receives and acquires the operational status information transmitted from the control device 21 (Step S107). The acquisition unit 41 receives and acquires the user situation information from the user situation acquisition sensor 300 (Step S108).

The status detection unit 42 extracts the recommended operation mode of the powered suit 100 according to the operational status information and user situation information that have been acquired (Step S109). For example, first, the status detection unit 42 analyzes the current behavior of the user on the basis of the operational status information. The behavior includes, for example, “running”, “walking”, “stopping”, and the like. Subsequently, the status detection unit 42 determines the fatigue state of the user's body based on the biometric information included in the user situation information. For example, the status detection unit 42 compares the normal body temperature and heartbeat of the user with the biometric information acquired by reading from the storage unit 44, and determines the fatigue state based on the difference. The status detection unit 42 determines the surrounding environment state on the basis of the position information included in the user situation information. Specifically, the status detection unit 42 acquires the surrounding environment state such as the weather at the user's current position, the state of the passage, the status of the destination, companions of the user, or the status of other users.

The state of the passage includes whether the passage is flat, whether the passage is uphill or downhill in the direction of travel, whether the passage is a paved road, and the like. The status of the destination includes the distance from the current position to the destination, the estimated time of arrival at the destination, the weather at the destination, and the like. The estimated time of arrival is the time of arrival at the destination. Companions of the user includes information about companions accompanying the user. The status of other users includes location information of other users. The status detection unit 42 determines the cooperation state with a companion according to the companion of the user. For example, the status detection unit 42 determines that the cooperation state is high if the companion is a person close to the user, and determines that the cooperation state is low if the companion is not.

Then, the status detection unit 42 extracts the recommended operation mode based on the current user behavior, the current operation mode, the fatigue state, and the surrounding environment state. For example, when the current user behavior is “walking”, the operation mode is “running”, and the fatigue state is “high”, the status detection unit 42 extracts “walking” as the recommended operation mode. When the current user behavior is “walking” and the state of the passage is “uphill”, the status detection unit 42 extracts “uphill walking”, in which the assist force is stronger than normal “walking”, as the recommended operation mode. Assist force is a force for reducing the load, and specifically is the magnitude of the torque output by the hip actuator 13, the knee actuator 14, and the ankle actuator 15. When the cooperation state with a companion is high, the status detection unit 42 extracts “cooperative walking”, in which the assist force is weaker than normal “walking”, as the recommended operation mode.

The operation control unit 43 notifies the control device 21 of the recommended operation mode extracted by the status detection unit 42 (Step S110). At this time, the operation control unit 43 may notify the control device 21 of other reference information together with the recommended operation mode. The operation control unit 43 determines whether or not to end the process (Step S111). When the process is not ended, the load reduction assistance device 400 performs control to repeat the process from Step S107. Thereby, the load reduction assistance device 400 repeats the process of extracting the recommended operation mode based on the operational status information and the user situation information and notifying the powered suit 100.

The drive control unit 211 of the control device 21 drives the hip actuator 13, the knee actuator 14, and the ankle actuator 15 in the recommended operation mode notified from the load reduction assistance device 400 (Step S112). The recommended operation mode may be one that indicates a control parameter such as a correction coefficient that corrects each torque value, calculated by the drive control unit 211 and output to the hip actuator 13, the knee actuator 14, and the ankle actuator 15. The drive control unit 211 multiplies the correction coefficient corresponding to the recommended operation mode by the value of each torque calculated by a predetermined torque calculation formula and output to the hip actuator 13, the knee actuator 14, and the ankle actuator 15. The drive control unit 211 outputs the torque value obtained as a result to the hip actuator 13, the knee actuator 14, and the ankle actuator 15.

Specifically, the drive control unit 211 acquires a control parameter of the control pattern corresponding to the recommended operation mode from the storage unit or the like. Then, using the sensing information indicating the current value and the angle reference of each joint, the drive control unit 211 calculates the target value of torque before correction output by the hip actuator 13, the knee actuator 14, and the ankle actuator 15 based on the control parameter and algorithm corresponding to the determined motion. The drive control unit 211 uses the sensing information indicating the current value acquired from at least one of the shoe sole load sensor 18, the foot sole load sensor 19, the hip joint sensor 23, the knee joint sensor 24, the ankle joint sensor 25, or the acceleration sensor 26.

The drive control unit 211 controls the rotation angles of the hip actuator 13, the knee actuator 14, and the ankle actuator 15 with the angle controller K_{ci}(s) on the basis of the target value of the torque. “s” indicates the frequency domain of the control system. Subsequently, the drive control unit 211 causes the hip actuator 13, the knee actuator 14, and the ankle actuator 15 of each leg to output the torque τ with a force controller K_{bi}(s).

Thereby, the interaction force Fₖ between suits and person applied by the user, the applied torque lₖ applied by the user, and the output torque τ in the kth of the time series (current value) become the dynamics P(s) of each actuator. The hip joint sensor 23, the knee joint sensor 24, and the ankle joint sensor 25 detect each joint angle θₖ at the kth of the time series according to the dynamics G(s) of the powered suit 100 based on the dynamics P(s) of the hip actuator 13, the knee actuator 14, and the ankle actuator 15. Then, the control device 21 repeats the above-described processing.

Note that the drive control unit 211 calculates the torque τ using the following torque calculation formula as an example. In this torque calculation formula (1), “(θ)/G(s)” indicates a feedback factor to the drive control unit 211. “Fₖ·lₖ” indicates a feedforward factor. Tᵢ indicates the target value of the torque prior to correction. f(θ) indicates a function including an angle θ based on the angle reference of the hip actuator 13, the knee actuator 14, and the ankle actuator 15. The torque calculation formula below is an example, and a formula other than the torque calculation formula shown below may be used. In the torque calculation formula (1), “s” indicates the frequency domain of the control system, K_{bi} indicates the control model of the force controller, and K_{ci} indicates the control model of the angle controller.

τ=K_{bi}(s){Tᵢ·K_{ci}(s)−f(θ)/G(s)+Fₖ·lₖ} (1)

The display control unit 215 may display reference information on the display unit 30 when the reference information is added to the recommended operation mode. The drive control unit 211 determines whether or not to end the process (Step S113). When the control device 21 does not end the process, the control device 21 performs control to repeat the process from Step S105. As a result, the control device 21 repeats the process of transmitting the operational status information to the load reduction assistance device 400.

According to the above processing, the status detection unit 42 of the load reduction assistance device 400 extracts the recommended operation mode of the powered suit 100 based on the user situation information and the operational status information, and the operation control unit 43 notifies the recommended operation mode. As a result, the load reduction assistance device 400 operates the powered suit 100 in the recommended operation mode. Therefore, it is possible to set the operation mode of the powered suit 100 to the optimum state by utilizing various pieces of information such as the user's fatigue state, the operational status of the powered suit 100, the surrounding environment state, and the cooperation state with a companion. Therefore, it is possible to provide load reduction and fatigue reduction more suited to the user.

In addition, by the above processing, when acting in a team with many companions, the optimum recommended operation mode as a team may be extracted based on user situation information such as the fatigue state of each user belonging to the team, and torque control using the recommended operation mode may be performed. As a result, it is possible to perform more efficient load reduction as compared with the case of acting alone or carrying luggage without using the powered suit 100.

### Second Embodiment

Next a second embodiment will be described.

Since the configuration of the load reduction assistance system 51 of the present embodiment is the same as that of the first embodiment, the description thereof will be omitted. In the first embodiment, the load reduction assistance device 400 extracts only one recommended operation mode and notifies the control device 21. The second embodiment differs from the first embodiment on the point of the load reduction assistance device 400 extracting a plurality of recommended operation modes and notifying the control device 21, and the control device 21 allowing the user to select one from the plurality of recommended operation modes.

That is, the status detection unit 42 of the load reduction assistance device 400 extracts multiple operation modes of the powered suit 100 in accordance with the operational status of the powered suit 100, the surrounding environment state based on the user's position information, and the fatigue state based on the user's biometric information.

The operation control unit 43 notifies the control device 21 of the powered suit 100 of the extracted plurality of operation modes.

The display control unit 215 of the control device 21 displays the notified plurality of operation modes on the display unit 30 so that the user can make a selection.

The drive control unit 211 drives the hip actuator 13, the knee actuator 14, and the ankle actuator 15 in the operation mode selected by the user on the display unit 30, to reduce the load on the user.

FIG. 8 is a diagram showing the processing flow of the load reduction assistance system according to the present embodiment. In the example of FIG. 8, the case where the load reduction assistance device 400 communicates with one control device 21 is illustrated, but the same applies to the case where the load reduction assistance device 400 communicates with a plurality of control devices 21.

Since the processes from Step S201 to Step S208 are the same as the processes from Step S102 to Step S108 described above, the descriptions thereof will be omitted.

Following Step S208, the status detection unit 42 extracts a plurality of recommended operation modes of the powered suit 100 according to the acquired operational status information and user situation information (Step S209).

For example, the status detection unit 42 extracts a predetermined number of recommended operation modes in descending order of priority.

The operation control unit 43 notifies the control device 21 of the plurality of recommended operation modes extracted by the status detection unit 42 together with their priorities (Step S210). At this time, the operation control unit 43 may notify the control device 21 of other reference information together with the recommended operation modes. The operation control unit 43 determines whether or not to end the process (Step S211). When the load reduction assistance device 400 does not end the process, the load reduction assistance device 400 performs control to repeat the process from Step S207. As a result, the load reduction assistance device 400 repeats the process of extracting recommended operation modes based on the operational status information and the user situation information and notifying the powered suit 100.

The display control unit 215 of the control device 21 displays the plurality of recommended operation modes notified from the load reduction assistance device 400 on the display unit 30 to be selectable by the user (Step S212). At this time, if reference information has been added to the recommended operation modes, the display control unit 215 may display the reference information on the display unit 30.

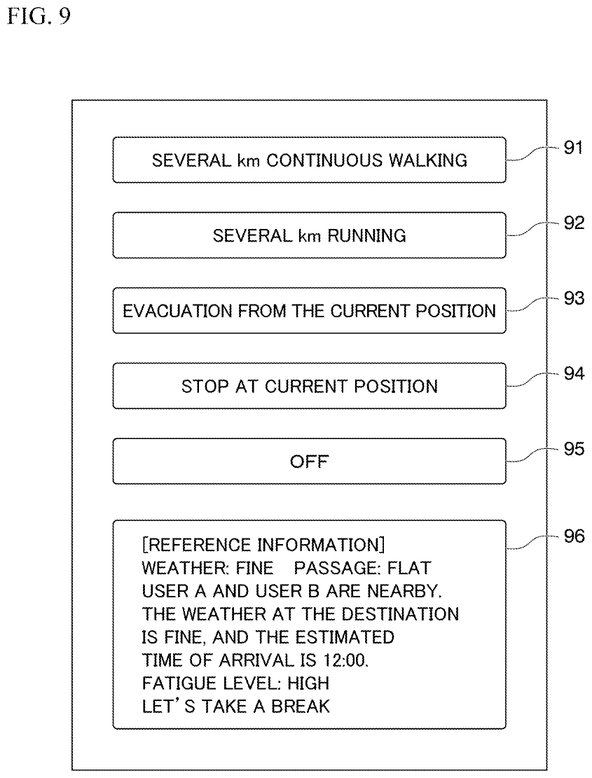

FIG. 9 is an image diagram showing an example of the operation mode selection screen according to the present embodiment.

In the example shown in this figure, the display control unit 215 selectably displays in the selection screen the recommended operation modes “Several km continuous walking” 91, “Several km running” 92, “Evacuation from the current position” 93, “Stop at current position” 94, and “OFF” 95 in descending order of priority from the top. The operation mode “OFF” is an operation mode that does not provide load reduction, that is, does not drive the hip actuator 13, the knee actuator 14, and the ankle actuator 15.

The display control unit 215 further displays the reference information 96 on the selection screen. In this example, the display control unit 215 displays as reference information in the selection screen: “Weather: fine”, the weather at the current position, “Passage: flat”, the state of the passage, and “User A and user B are nearby.”, giving notice of other users in the vicinity. The display control unit 215 also displays as reference information in the selection screen: “The weather at the destination is fine and the estimated time of arrival is 12:00.”, which provides the weather at the destination and the estimated time of arrival, and “Fatigue level: High—Let's take a break”, which gives notice of the user's fatigue state.

Note that the display control unit 215 may display a map when giving notice of other users in the vicinity, and may indicate the positions of the other users on the map. The display control unit 215 may display on the map a recommended position indicating the position where the user currently should be with respect to the destination together with the current position of the user.

Returning to FIG. 8, the user selects one from the plurality of recommended operation modes displayed on the display unit 30. The display unit 30 receives the selection input of the recommended operation mode (Step S213), and outputs the selected recommended operation mode to the control device 21. The drive control unit 211 of the control device 21 drives the hip actuator 13, the knee actuator 14, and the ankle actuator 15 in the recommended operation mode selected by the user (Step S214). The drive control unit 211 determines whether or not to end the process (Step S215). When the control device 21 does not end the process, the control device 21 performs control to repeat the process from Step S205. Thereby, the control device 21 repeats the process of transmitting the operational status information to the load reduction assistance device 400.

According to the above processing, the status detection unit 42 of the load reduction assistance device 400 extracts a plurality of recommended operation modes of the powered suit 100 on the basis of the user situation information and the operational status information, and the operation control unit 43 gives notice of the plurality of recommended operation modes. Then, the display control unit 215 of the powered suit 100 displays to the user in a selectable manner the plurality of recommended operation modes about which notice has been given. The drive control unit 211 drives the hip actuator 13, the knee actuator 14, and the ankle actuator 15 in the recommended operation mode selected by the user. Thereby, in addition to the effect in the first embodiment, it is possible to provide optimum load reduction and fatigue reduction that reflect the intention of the user.

In the first embodiment and the second embodiment described above, the load reduction assistance device 400 may also specify the recommended operation mode using an integrated judgment function by means of machine learning when specifying a recommended operation mode on the basis of the operational status information and the user situation information of a plurality of users belonging to a team.

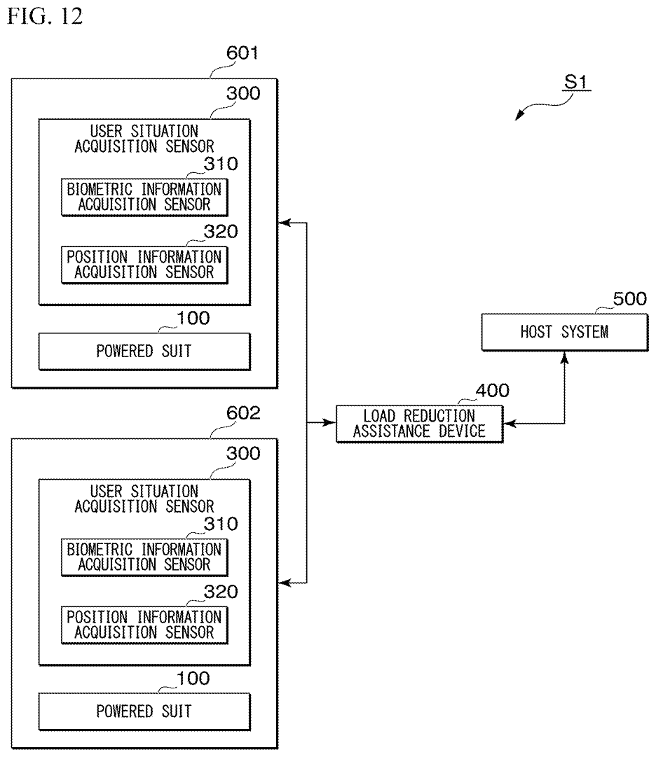

FIG. 12 is a diagram showing a configuration of a load reduction assistance system having a plurality of user situation acquisition sensors 300 and powered suits 100. The load reduction assistance system S1 shown in FIG. 12 is provided with a plurality of load reduction units 601 and 602 each including the user situation acquisition sensor 300 and the powered suit 100.

The load reduction assistance device 400 acquires state information including the user's position information from each of the plurality of user situation acquisition sensors 300. The state information may include, for example, the fatigue state and an surrounding environment state. The load reduction assistance device 400 extracts a reference model in accordance with machine learning using the acquired state information about a plurality of users. That is, the load reduction assistance device 400 extracts the recommended operation mode of each of the plurality of powered suits 100 according to machine learning. The load reduction assistance device 400 operates each powered suit 100 according to the extracted recommended operation mode.

For example, the load reduction assistance device 400 specifies an ideal movement pattern of a team to which a plurality of users using the powered suit 100 belong, and a reference model based on the behavior pattern. The load reduction assistance device 400 machine-learns various sensing data (fatigue state, surrounding environment state, and the like) that can be repeatedly acquired for the current plurality of users, and extracts a reference model including the recommended operation pattern of the plurality of users. That is, the load reduction assistance device 400 specifies a reference model that realizes optimal cooperative behavior by the plurality of users based on the fatigue state and the surrounding environment state of the plurality of users.

The plurality of recommended operation patterns of the reference model may be the same among a plurality of users or may be different from each other. When the recommended operation patterns differ from each other among the plurality of users, the recommended operation pattern of each user is specified according to, for example, sensing data.

The load reduction assistance device 400 compares the specified reference model with the current operation pattern extracted from the sensing data of each user and extracts the difference. For a plurality of users, the load reduction assistance device 400 determines the operation of the users based on the difference.

The drive control unit 211 controls the output torque for the plurality of users with a control pattern according to the operation determined by the load reduction assistance device 400. That is, the control device 21 acquires the control parameters of the control pattern of each user corresponding to the specified reference model from a plurality of reference models stored in advance in the storage unit or the like.

Then, the drive control unit 211 sets the optimum control parameters for the plurality of users according to the difference between the determined current operation pattern and the reference model. The drive control unit 211, using the sensing information indicating the current value and the angle reference of each joint, calculates the target value of the torque output by hip actuator 13, the knee actuator 14, and the ankle actuator 15 based on the control parameters and algorithms corresponding to the determined operation. The drive control unit 211 uses sensing information indicating the current value acquired from at least one of the shoe sole load sensor 18, the foot sole load sensor 19, the hip joint sensor 23, the knee joint sensor 24, the ankle joint sensor 25, or the acceleration sensor 26. The drive control unit 211 outputs the torque τ at the current time calculated by the torque calculation formula using the target value of the torque to the calculated hip actuator 13, knee actuator 14, and ankle actuator 15 of each leg.

The team to which the above-mentioned plurality of users belong may be, for example, an administrative unit such as a fire brigade, a police unit, a mountain unit, a nuclear accident-related unit, or a coastal sea area rescue unit.

When the powered suit 100 is used by a fire brigade, for example, in a large-scale fire extinguishing activity, the load reduction assistance device 400, as ascertainment of the surrounding situation, identifies the place where the fire is severe and the place where it is difficult to secure a water discharge route. Then, the load reduction assistance device 400 can perform appropriately coordinated load reduction processing by the recommended operation mode according to the arrangement of the firefighters, serving as a plurality of users belonging to the fire brigade.

When used by a police unit, for example, the powered suit 100 can identify the road congestion status and route condition for tracking a perpetrator, and can perform appropriate load reduction processing by the recommended operation mode according to the police unit member serving as a user belonging to the police unit. As a result, the police officers as a plurality of users can cooperate with each other according to their respective recommended operation modes and efficiently perform the action of pursuing the perpetrator.

When used by a mountain unit, for example, the powered suit 100 can specify the surrounding conditions such as the gradient of the slope and the width of the search range in the mountain rescue work and the optimum route, and can perform appropriate load reduction processing by the recommended operation mode according to the mountain member. As a result, the mountain members as a plurality of users can cooperate with each other according to their respective recommended operation modes and perform efficient rescue activities.

When used in an accident work unit, for example, the powered suit 100 can for example perform specification of the work environment in the work of the work unit member, specify the surrounding damage situation, and perform appropriate load reduction processing by the recommended operation mode according to the work unit member. As a result, the workers as a plurality of users can cooperate with each other according to their respective recommended operation modes and perform efficient accident response work.

When used by a coastal sea area rescue team, for example, the powered suit 100 specifies the conditions around the sea and underwater (presence of tetrapods, presence of soft terrain, presence of rough terrain, and the like) in the rescue work of team members. Then, the powered suit 100 can perform appropriate load reduction processing by the recommended operation mode according to the team members. As a result, the members as a plurality of users can cooperate with each other according to their respective recommended operation modes and perform efficient rescue work.

Although one embodiment of the present invention has been described above, the present invention is not limited to the above-described embodiment, and various modifications can be made within a scope not departing from the spirit of the present invention.

For example, the shoe sole load sensor 18 may be provided in advance on a side of the ground contact surface of the shoe sole plate 16 of the powered suit 100. Also, the foot sole load sensor 19 may be inserted in advance inside the foot harness 17.

In the above description, it was shown that the shoe sole load sensor 18 has an area covering the entire underside of the foot harness 17, and the foot sole load sensor 19 has an area covering the entire underside of the foot in the foot harness 17. However, the shoe sole load sensor 18 may be capable of measuring the load applied to the ground contact surface from the shoe sole plate 16 or the foot harness 17 even when the position where the load is applied deviates.

In the above description, the case of controlling the powered suit 100 was illustrated, but the control device 21 is not limited thereto, and can be applied to general control of a multi-joint robot or the like (for example, a humanoid robot) having a non-linear mode transition.

In the above description, the powered suit 100 is provided with the hip actuator 13, the knee actuator 14, and the ankle actuator 15 corresponding respectively to each joint, but is not limited thereto. The powered suit 100 may have at least one of the hip actuator 13, the knee actuator 14, and the ankle actuator 15. For example, the powered suit 100 may be provided with at least the hip actuator 13 and the knee actuator 14, and does not have to be provided with the ankle actuator 15. Alternatively, the ankle actuator 15 may be an actuator that does not use a control signal, such as a mechanical leaf spring.

In the above description, the powered suit 100 is provided with both the shoe sole load sensor 18 and the foot sole load sensor 19, but is not limited thereto, and either one of the shoe sole load sensor 18 and the foot sole load sensor 19 may be provided.

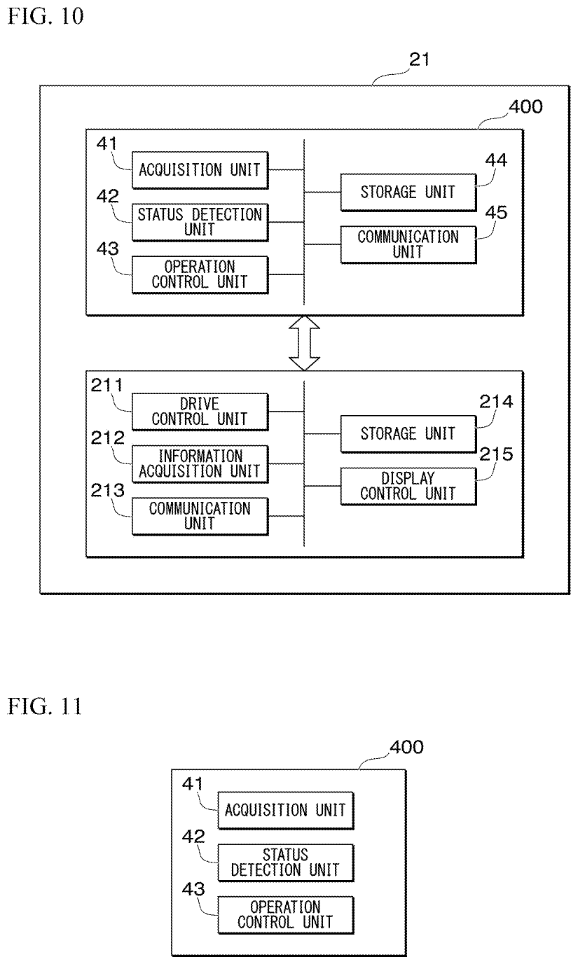

FIG. 10 is a diagram showing another example of the control device.

In the above example, the case where the control device 21 and the load reduction assistance device 400 are connected by wireless communication was used for explanation. However, the load reduction assistance device 400 may be equipped inside the control device 21 and provided in the powered suit 100. By providing the load reduction assistance device 400 inside the control device 21, delay in data transmission/reception can be prevented. Therefore, it is possible to respond in real time without delay even to a sudden operation of the user.

FIG. 11 is a diagram showing the minimum configuration of the load reduction assistance device.

The load reduction assistance device may have at least the functions of the acquisition unit 41, the status detection unit 42, and the operation control unit 43.

The acquisition unit 41 acquires the user's location information.

The status detection unit 42 extracts the operation mode of the powered suit 100 according to the surrounding environment state based on the user's position information.

The operation control unit 43 causes the powered suit 100 to operate in the extracted operation mode.

Each device mentioned above may also be a computer provided with hardware such as the CPU (Central Processing Unit) 101, the ROM (Read Only Memory) 102, the RAM (Random Access Memory) 103, an HDD (Hard Disk Drive) 104, and the wireless communication device 105.

Each device described above has a computer system inside. The process of each processing described above is stored in a computer-readable recording medium in the form of a program, with the process being performed by the computer reading and executing this program. Here, the computer-readable recording medium refers to a magnetic disk, a magneto-optical disk, a CD-ROM, a DVD-ROM, a semiconductor memory, or the like. This computer program may be distributed to a computer via a communication line, and the computer receiving the distribution may execute the program.

Further, the above-mentioned program may be for realizing some of the functions described above.

Moreover, the above-mentioned program may be a so-called differential file (differential program) that can realize the above-mentioned functions in combination with a program already recorded in the computer system.

Some or all of the embodiments described above can be described as in the following supplementary notes, but are not limited thereto.

(Supplementary Note 1) A load reduction assistance system that is a load reduction assistance system provided with a load reduction assistance device and a load reduction device that reduces a load on a user, in which the load reduction assistance device is provided with an acquisition unit configured to acquire position information of the user; a status detection unit configured to extract an operation mode of the load reduction device corresponding to a surrounding environment state based on the position information of the user; and an operation control unit configured to cause the load reduction device to operate in the extracted operation mode.

(Supplementary Note 2) The load reduction assistance system according to Supplementary Note 1, in which the acquisition unit further acquires biometric information of the user, and the status detection unit extracts the operation mode in accordance with a fatigue state based on the biometric information of the user.

(Supplementary Note 3) The load reduction assistance system according to Supplementary Note 1 or Supplementary Note 2, in which the acquisition unit further acquires the operational status of the load reduction device, and the status detection unit extracts an operation mode on the basis of the operational status of the load reduction device.

(Supplementary Note 4) The load reduction assistance system according to any one of Supplementary Note 1 to Supplementary Note 3, in which the status detection unit extracts a plurality of operation modes, the operation control unit notifies the load reduction device of a plurality of operation modes, and the load reduction device is provided with a display unit configured to display, in a manner selectable by the user, the plurality of operation modes about which notification has been received, and a drive mechanism configured to reduce the load on the user in the operation mode selected by the user.

(Supplementary Note 5) The load reduction assistance system according to any one of Supplementary Note 1 to Supplementary Note 4, in which the operation control unit notifies the load reduction device of reference information based on the surrounding environment state along with the operation modes, and the load reduction device further comprises display unit configured to display the reference information about which notification has been received.

(Supplementary Note 6) The load reduction assistance system according to any one of Supplementary Note 1 to Supplementary Note 5, wherein the surrounding environment state includes any one of weather, a state of a passage, companions, or other user situations.

(Supplementary Note 7) A load reduction assistance device provided with an acquisition unit configured to acquire position information of a user wearing a load reduction device that reduces a load on the user, a status detection unit configured to extract an operation mode of the load reduction device corresponding to a surrounding environment state based on the position information of the user; and an operation control unit configured to cause the load reduction device to operate in the extracted operation mode.

(Supplementary Note 8) The load reduction assistance device according to Supplementary Note 7, in which the acquisition unit further acquires biometric information of the user, and the status detection unit extracts the operation mode in accordance with a fatigue state based on the biometric information of the user.

(Supplementary Note 9) The load reduction assistance device according to Supplementary Note 7 or Supplementary Note 8, in which the acquisition unit further acquires an operational status of the load reduction device, and the status detection unit extracts the operation mode on the basis of the operational status of the load reduction device.

(Supplementary Note 10) The load reduction assistance device according to any one of Supplementary Note 7 to Supplementary Note 9, in which the status detection unit extracts a plurality of operation modes, and the operation control unit, by giving notice of the plurality of operation modes, causes the load reduction device to display the plurality of operation modes in a manner selectable by the user.

(Supplementary Note 11) The load reduction assistance device according to any one of Supplementary Note 7 to Supplementary Note 10, in which the operation control unit causes the load reduction device to display reference information, by notifying the load reduction device of the reference information based on the surrounding environment state along with the operation mode.

(Supplementary Note 12) The load reduction assistance device according to any one of Supplementary Note 7 to Supplementary Note 11, in which the surrounding environment state includes any one of weather, a state of a passage, companions, or other user situations.

(Supplementary Note 13) A load reduction assistance method comprising: acquiring position information of a user wearing a load reduction device that reduces a load on the user, extracting an operation mode of the load reduction device corresponding to a surrounding environment state based on the position information of the user, and causing the load reduction device to operate in the extracted operation mode.

(Supplementary Note 14) A storage medium that stores a program that causes a computer of a load reduction assistance device to execute processes, the processes comprising: acquiring position information of a user wearing a load reduction device that reduces a load on the user, extracting an operation mode of the load reduction device corresponding to a surrounding environment state based on the position information of the user, and causing the load reduction device to operate in the extracted operation mode.

Priority is claimed on Japanese Patent Application No. 2018-212804, filed Nov. 13, 2018, the content of which is incorporated herein by reference.

### INDUSTRIAL APPLICABILITY

According to the present invention, it is possible to provide more suitable load reduction control corresponding to the situation of a user.

### REFERENCE SIGNS LIST

S1: Load reduction assistance system

100: Powered suit

11: Skeleton portion

12: Belt

13: Hip actuator

14: Knee actuator

15: Ankle actuator

16: Shoe sole plate

17: Foot harness

18: Shoe sole load sensor

19: Foot sole load sensor

20: Loading platform

21: Control device

22: Battery

23: Hip joint sensor

24: Knee joint sensor

25: Ankle joint sensor

30: Display unit

211: Drive control unit

212: Information acquisition unit

213: Communication unit

214: Storage unit

215: Display control unit

300: User situation acquisition sensor

310: Biometric information acquisition sensor

320: Position information acquisition sensor

400: Load reduction assistance device

41: Acquisition unit

42: Status detection unit

43: Operation control unit

44: Storage unit

45: Communication unit

500: Host system

What is claimed is:

1. A load reduction assistance device comprising:
at least one memory configured to store instructions; and
at least one processor configured to execute the instructions to;
acquire position information of a user wearing a load reduction device that reduces a load on the user;
extract an operation mode of the load reduction device corresponding to a surrounding environment state based on the position information of the user; and
cause the load reduction device to operate in the extracted operation mode.

2. The load reduction assistance device according to claim 1,
wherein the at least one processor is configured to execute the instructions to:
acquire further biometric information of the user, and
extract the operation mode in accordance with a fatigue state based on the biometric information of the user.

3. The load reduction assistance device according to claim 1,
wherein the at least one processor is configured to execute the instructions to:
acquire further an operational status of the load reduction device, and
extract the operation mode on the basis of the operational status of the load reduction device.

4. The load reduction assistance device according to claim 1,
wherein the at least one processor is configured to execute the instructions to:
extract a plurality of operation modes, and
cause, by giving notice of the plurality of operation modes, the load reduction device to display the plurality of operation modes in a manner selectable by the user.

5. The load reduction assistance device according to claim 1,
wherein the at least one processor is configured to execute the instructions to:
notify the load reduction device of reference information based on the surrounding environment state along with the operation mode.

6. The load reduction assistance device according to claim 1,
wherein the at least one processor is configured to execute the instructions to:
cause the load reduction device to display reference information by notifying the load reduction device of the reference information based on the surrounding environment state along with the operation mode.

7. The load reduction assistance device according to claim 1, wherein the surrounding environment state includes any one of weather, a state of a passage, companions, or other user situations.

8. A load reduction assistance system comprising a load reduction assistance device and a load reduction device that reduces a load on a user, wherein the load reduction assistance device comprises:
at least one first memory configured to store instructions; and
at least one first processor configured to execute the instructions to;
acquire position information of the user;
extract an operation mode of the load reduction device corresponding to a surrounding environment state based on the position information of the user; and
cause the load reduction device to operate in the extracted operation mode.

9. The load reduction assistance system according to claim 8,
wherein the at least one first processor is configured to execute the instructions to:
acquire further biometric information of the user, and
extract the operation mode in accordance with a fatigue state based on the biometric information of the user.

10. The load reduction assistance system according to claim 8,
wherein the at least one first processor is configured to execute the instructions to:
acquire further an operational status of the load reduction device, and
extract the operation mode on the basis of the operational status of the load reduction device.

11. The load reduction assistance system according to claim 8,
wherein the at least one first processor is configured to execute the instructions to:
extract a plurality of operation modes,
notify the load reduction device of a plurality of operation modes, and
the load reduction device comprises
at least one second memory configured to store instructions; and
at least one second processor configured to execute the instructions to;
display, in a manner selectable by the user, the plurality of operation modes about which notification has been received, and
reduce the load on the user in the operation mode selected by the user.

12. The load reduction assistance system according to claim 8,
wherein the at least one first processor is configured to execute the instructions to:
notify the load reduction device of reference information based on the surrounding environment state along with the operation mode, and
wherein the at least second first processor is configured to execute the instructions to:
display the reference information about which notification has been received.

13. The load reduction assistance system according to claim 8, wherein the surrounding environment state includes any one of weather, a state of a passage, companions, or other user situations.

14. The load reduction assistance system according to claim 8, comprising a plurality of load reduction devices,
wherein the at least one first processor is configured to execute the instructions to:
acquire the position information of the user from the plurality of load reduction devices;
extract the operation mode of each of the plurality of load reduction devices; and
cause the plurality of load reduction devices to operate in the extracted operation modes, respectively.

15. A load reduction assistance method comprising:
acquiring position information of a user wearing a load reduction device that reduces a load on the user;
extracting an operation mode of the load reduction device corresponding to a surrounding environment state based on the position information of the user; and
causing the load reduction device to operate in the extracted operation mode.

16-17. (canceled)
